(19) United States
(12) Patent Application Publication
(10) Pub. No.: US 2009/0150631 A1
(43) Pub. Date: Jun. 11, 2009

(54) SELF-PROTECTING STORAGE DEVICE

(75) Inventors: Philip A. Wilsey, Cincinnati, OH (US); Roy Brian Anderson, Cincinnati, OH (US); Mike Borowczak, North Canton, OH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: CLIFTON LABS, INC., Cincinnati, OH (US)

(21) Appl. No.: 12/328,034

(22) Filed: Dec. 4, 2008

Related U.S. Application Data
(60) Provisional application No. 60/992,751, filed on Dec. 6, 2007.
(60) Provisional application No. 61/103,314, filed on Oct. 7, 2008.

(51) Int. Cl. G06F 12/00

(52) U.S. Cl. 711/163; 711/E12.093

(57) ABSTRACT

Described are a self-protecting storage device and method that can be used to monitor attempts to access protected information. Access is allowed for authorized host systems and devices while unauthorized access is prevented. Authorization use includes inserting a watermark into access commands, such as I/O requests, sent to the storage device. The access commands are verified before access is permitted. In one embodiment, block addresses in I/O requests are encrypted at the host device and decrypted at the self-protecting storage device. Decrypted block addresses are compared to an expected referencing pattern. If a sufficient match is determined, access to the stored information is provided. Self-protection can be provided to a range of storage devices including, for example, SD flash memory, USB thumb drives, computer hard drives and network storage devices. A variety of host devices can be used with the self-protecting storage devices, such as cell phones and digital cameras.

### RELATED APPLICATION

This application claims the benefit of the filing dates of co-pending U.S. Provisional Application Ser. No. 60/992,751, filed Dec. 6, 2007, titled “Self-Protecting Storage” and co-pending U.S. Provisional Application Ser. No. 61/103,314, filed Oct. 7, 2008, titled “Secure Anti-Tamper Storage Device,” the entireties of which provisional applications are incorporated by reference herein.

### FIELD OF THE INVENTION

The invention relates generally to protecting to private and confidential information. More particularly, the invention relates to a self-protecting storage device that prevents unauthorized access to information stored on the device.

### BACKGROUND OF THE INVENTION

Protecting sensitive information has become more important as the number of electronic devices such as cell phones, digital cameras, personal digital assistants (PDAs) and personal computers (PCs) continues to increase. Information in the form of data and instructions are stored, for example, in random access memory (RAM) on an electronic device and can include valuable processing techniques or algorithms (e.g., software applications) which can be used to access or process sensitive data. If the device is obtained by an unauthorized user, reverse engineering procedures can sometimes be used to extract the information and to allow the unauthorized user to access other sensitive data. The portability of many electronic devices makes sensitive data stored on the devices particularly susceptible to unauthorized access. For example, personal information stored in a cell phone is at risk when the cell phone is lost or misplaced. The continued migration of personal and payment information into such devices magnifies the problem.

Several techniques are commercially available to protect data saved in flash memory storage devices (e.g., a universal serial bus (“USB”) storage device), namely: (i) the encryption of the stored data, (ii) the creation of a password protection mechanism in the device, and (iii) the addition of a biometric fingerprint reader on the device. While highly effective against weak attack methods, encryption can often be defeated by a determined attacker. Likewise, passwords and fingerprinting provide only modest protection and there have been numerous reports depicting the defeat of password and biometric protected USB drives. Some techniques for bypassing password protection require hardware modifications while other techniques rely on modifications to software device drivers. In the case of fingerprint drives, there are reports of successful circumvention of fingerprint security in a variety of devices, including one report of successful access based on modifications to the software binary so that the drive bypasses the fingerprint scan.

Key problems with the existing protection mechanisms for flash memory devices arise because the protection is enforced using software and hardware that is easily accessible to the attacker, and because the information protection mechanisms do not have an ongoing and sustained process to look for an intrusion event.

What is needed is a method for protecting data and instructions stored in memory devices that overcomes the problems described above.

### SUMMARY OF THE INVENTION

In one aspect, the invention features a self-protecting storage device. The storage device includes a data storage module and a verification module. The verification module communicates with the data storage module and is adapted to receive access commands from a host system. The verification module is configured to detect a watermark inserted into the access commands by the host system and to determine if the watermark is associated with an authorized attempt to access the data storage module. The verification module enables access to the data storage module if the watermark is determined to be associated with an authorized attempt. In some embodiments, the watermark is a digital signature, a verification code, a predefined relationship between the access commands or the watermark comprises encrypted block addresses included in the access commands.

In another aspect, the invention features a method for accessing a protected storage device. A plurality of commands to access the protected storage device is generated and a watermark is inserted into the access commands. The access commands with the inserted watermark are sent to the protected storage device. Access to the protected storage device is provided if the watermark is determined to be associated with an authorized attempt to access the protected storage device.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a graphical representation of a process of adding a watermark to an input/output request sent by a host system and verifying the watermark at a self-protecting storage device according to an embodiment of the invention.

FIG. 2 is a functional block diagram illustrating the transfer of encrypted block addresses in input/output requests exchanged between a host system and a self-protecting storage device.

FIG. 3 is a flowchart representation of an embodiment of a method for accessing protected information in a storage device according to the invention.

FIG. 4 is a block diagram of a host system and self-protecting storage device during access of protected information according to an embodiment of the invention.

FIG. 5 is a graphical illustration of an example of block address progression for sequential input/output requests.

FIG. 6 is a graphical illustration of another example of block address progression for sequential input/output requests.

### DETAILED DESCRIPTION

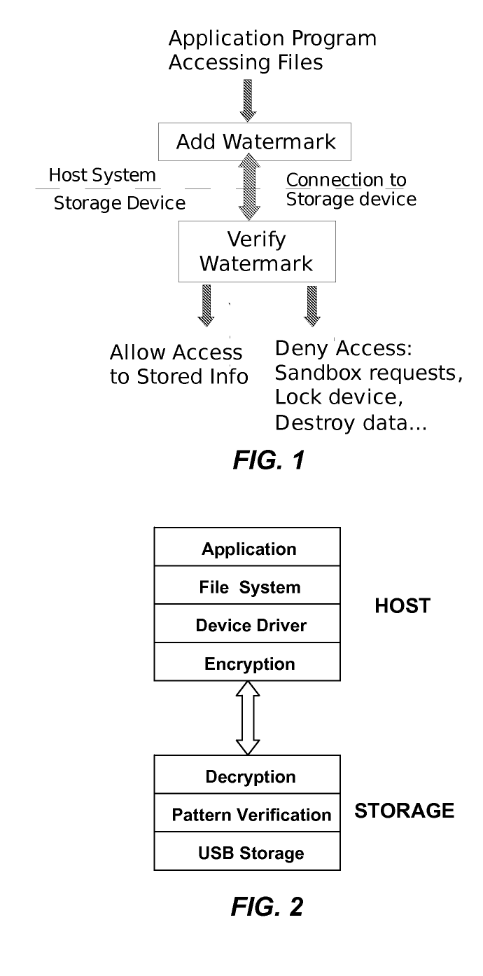

A self-protecting storage device according to the invention can be used without the need for changes or modification to systems that use the device. The storage device can be used to protect sensitive information so that if the device lost or misplaced, unauthorized attempts to access information stored on the device are not successful. Using a self-protecting storage device in a mobile electronics device such as a cell phone or digital camera, or in fixed or portable storage devices such as a computer hard drive, USB drive or network drive, provides protection of personal or sensitive information contained on the storage device if the host device is lost or stolen. Self-protection is implemented by adding a watermark to the access commands (e.g., input/output (“I/O”) requests) sent by the host system to the storage device as functionally depicted in FIG. 1. The self-protecting storage device examines and verifies the watermark before allowing the transfer of information to the host system that issued the request. Access commands sent to the device without a verifiable watermark can be ignored, sandboxed, or used to trigger a particular response (anti-tamper) event in the storage device.

Watermarking can be accomplished in a variety of ways. For example, a digital signature or code can be added to each access command. Alternatively, a watermark can be created by utilizing a predetermined pattern of access or by establishing a specific relationship between the access commands sent to the storage device.

In some embodiments, a specific pattern of access to the self-protecting storage device is matched with an encoding strategy to present a pattern that the storage device can verify. Access patterns to blocks in storage devices of computer systems are well behaved and follow patterns that can be monitored and matched. In general the access patterns are sequential progressions of increasing block addresses that are common across most file systems including file system definition, reformatting, and active use. For example, the block address can be repeatedly incremented by a value of one. In order to make access patterns non-obvious, the self-protecting storage device is configured to obfuscate the access patterns into recognizable but non-obvious patterns known only to the self-protecting storage device and the host systems authorized to access the information in the storage device.

In a preferred embodiment, an encryption scheme is used to encrypt the block addresses of the access commands exchanged between the accessing (host) system and the self-protecting storage device as functionally depicted in FIG. 2. Access is granted only when a verification module in the self-protecting storage device determines that the access pattern is authorized. Thus the device driver at the host system sends encrypted read/write addresses to the self-protecting storage device. The storage device decrypts the encrypted addresses and then tests the decrypted addresses for sequential progression. A progression of unit size 1, 2, or any other size can be enforced. Access to the stored information is allowed only when the sequential progression test is satisfied. In one embodiment, minor variations from an ideal sequential progression are allowed if such variations are considered reasonably probable during authorized attempts to access the stored information. A maximum allowable number of variations may be predetermined and used as a threshold for declaring whether the access attempts are authorized. Advantageously, the access pattern matching process provides practical protection from access attempts by unauthorized users. In one embodiment, the self-protecting storage device is a USB storage device configured for use with a Windows computer.

The self-protecting storage device continuously monitors and controls access to the stored information, and controls the ability to store information on the device. In one embodiment, the method used by the self-protecting storage device is implemented within the small computer system interface (SCSI) layer in a block device protocol stack. Consequently, the method is easily utilized in other block storage devices such as integrated drive electronics (IDE) drives, serial advanced technology attachment (SATA) drives, SCSI hard drives, network access storage devices, and other flash storage devices (e.g., compact flash and secure digital (SD) flash devices). Furthermore, because each self-protecting storage device has a unique encryption key, access can be controlled specifically and individually to each unique self-protecting storage device. Methods to share keys between devices can be a configuration time option. Other configurations are possible and may be preferred based on user interests and requirements. For example, a self-protecting storage device can operate with multiple encryption keys so that access is granted and revoked dynamically to individual computer systems. Thus individual system access to the self-protecting storage device can be strictly controlled. Access control policies are updated or revised after determining that the host device or system has been lost, or that a security or employment status change to a user of a specific host device or system has occurred.

Many hard disks, USB storage devices and other computer storage units operate as block storage devices that use SCSI commands to encode direct memory access (DMA) read and write requests. For example, a USB storage device typically includes two main components: a flash storage chip and a micro-controller to interface with a host system.

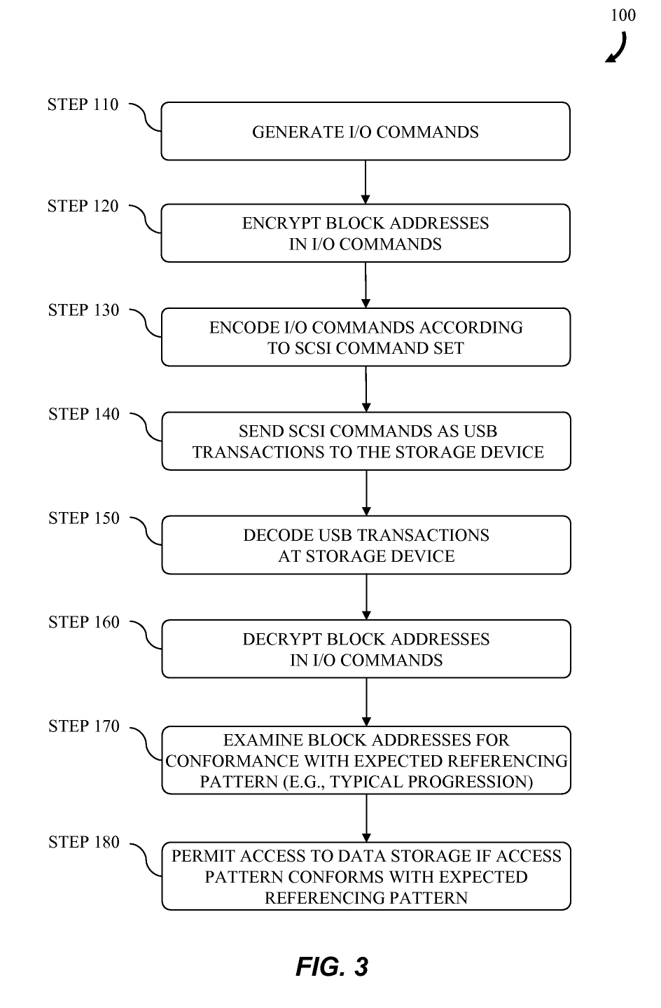

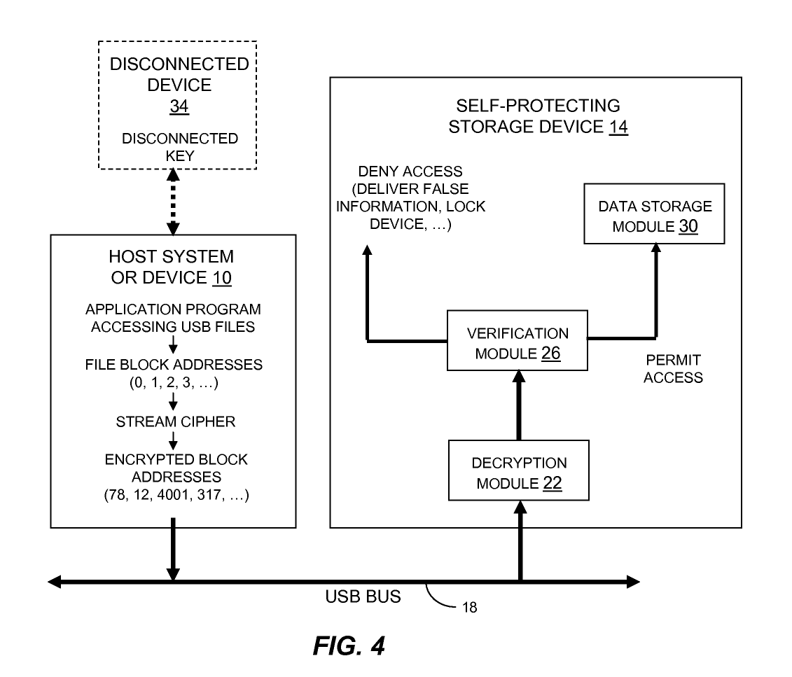

FIG. 3 is a flowchart representation of an embodiment of a method 100 for accessing protected information in a storage device according to the invention and FIG. 4 shows a block diagram of a host system 10 and the storage device 14 during access. Referring to FIG. 3 and FIG. 4, the host system 10 connects to the storage device 14 through a USB bus 18 and communications between the host system 10 and the storage device 14 occur as USB transactions. Some USB transactions are for device identification and characterization while other USB transactions relate to the reading of information from the storage device 14 or writing of information to the storage device 14. The USB transactions are defined according to a SCSI Transparent Command Set. According to the method 100, the host system 10 generates (step 110) commands (or “requests”) for accessing the self-protecting storage device 14. For example, the access commands can be generated during the execution of an application program on the host system 10. The access commands include references to file block addresses. These block addresses are encrypted (step 120) according to an encryption key and encoded (step 130) as SCSI commands according to the SCSI Transparent Command Set. Optionally, the encryption key is captured in order to be stored or used by other host systems and devices to establish authorized use of the self-protecting storage device 14. A device driver at the SCSI block layer in the host system 10 encodes (step 130) the SCSI commands into USB transactions which are then sent (step 140) to the self-protecting storage device 14. User configuration capability is preferably provided by the device driver so that the self-protecting storage device 14 can be configured (or reconfigured) according to various security models and policies.

Once received at the storage device 14, the USB transactions are decoded (step 150) and the block addresses in the access commands are decrypted (step 160) by a decryption module 22. The decrypted block addresses are examined by a verification module 26 to see if they sufficiently match (step 170) a predetermined expected pattern of block addresses for an authorized user. For example, the decrypted block addresses may be compared to the predetermined pattern. Subsequently, if the decrypted block addresses are sufficiently matched to the predetermined pattern, the verification module 26 permits access (step 180) to the protected data in a data storage module (e.g., flash storage chip) 30 to effect the I/O transactions according to the encoded SCSI commands.

If a proper match is not determined, the self-protecting storage device 14 can initiate execution of one or more predetermined functions. For example, a predetermined function can include:
erasure (e.g., deletion) of some or all of the protected data;
providing access to stored false data;
locking (i.e., preventing access to) the storage device so that access is denied until an unlock sequence is received; and
locking the storage device so that access is denied for a predetermined time period.

In one embodiment, the self-protecting storage device 14 reports its maximum DMA read/write length to the host system 10. Thus the amount of data accessible on an individual read/write request can be limited, for example, to one block. Consequently, the number of host requests against which pattern matching is performed is increased and therefore the level of security is also increased.

In another embodiment, the comparison of the decrypted block addresses to the predetermined referencing pattern of block addresses is performed as a trust building match process. A saturating counter is used to track the level of trust between the host system 10 and the self-protecting storage device 14. A value generated by the saturating counter indicates the degree to which the decrypted block addresses match the predetermined pattern of block addresses. When the block addresses associated with the received read/write requests are serially progressing, a value of the saturating counter is increased. When block addresses that do not correspond to the serial progression are received, the value of the saturating counter is decreased. Thus higher levels of trust are represented by greater values. The verification module 26 uses the value of the saturating counter to determine which requests are authorized and which requests are unauthorized.

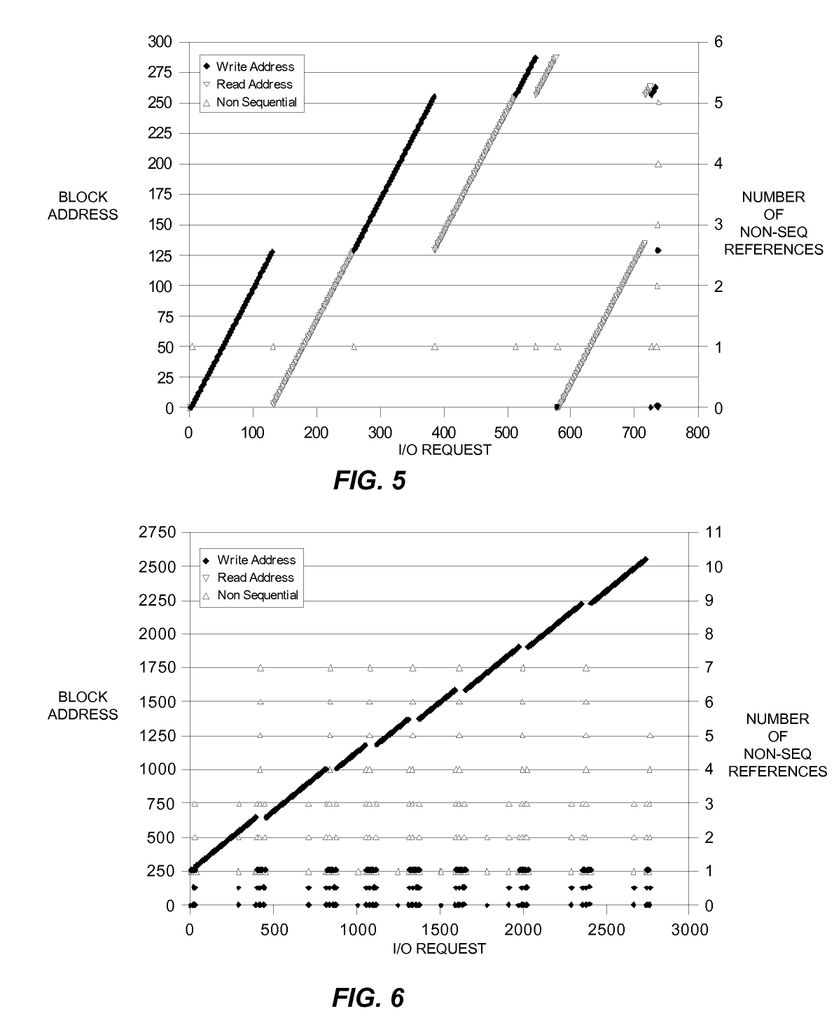

FIG. 5 and FIG. 6 graphically depict examples in which multi-block SCSI transactions from an application executed on a host system are rewritten into single block SCSI transfers. FIG. 5 shows data for the block address progression from a FAT format command and FIG. 6 shows data from the writing of a 2,100 Kbyte file. In both figures the horizontal axis indicates the sequence of the device SCSI access requests, the left vertical axis indicates the block addresses and the right vertical axis indicates the number of non-sequential accesses. As shown, a majority of the accesses correspond to a sequential progression that can be encrypted by the host system, exchanged, decrypted at the storage device and examined to determine any non-confirming intrusion events.

Although self-protection is described above primarily according to a matching of block addresses in received requests to a predetermined (e.g., expected) pattern of block addresses, the invention contemplates that matching can also be based on other attributes of access commands. Such attributes can be, by way of example, a cryptographic signature or a special code added to I/O requests, the relations of the read and write requests, the lengths of DMA transfers, a hidden key field in the access requests, or other referencing patterns and behaviors.

In embodiments described above, the self-protecting storage device stores information at the decrypted block addresses. In an alternative embodiment, the self-protecting storage device does not decrypt block address in write requests. Instead, the information is written to the storage device using the encrypted block addresses and decryption is used to verify that the proper access pattern has occurred. Consequently, a further increase in the level of protection for stored information is achieved.

The encryption keys for a self-protecting storage device can be distributed in a variety of ways. For example, the keys can be managed manually, automatically from a database through secure communications such as a virtual private network (VPN), using special key fobs or through other mechanisms known in the art. Optionally, the keys are captured during connection to a VPN and used remotely for disconnected used while the user is “on travel.” In another option particularly suitable for portable and mobile devices, encryption keys are time-limited or use-limited.

A self-protecting storage device can operate with multiple encryption keys so that access can be granted and revoked dynamically to add or remove access to and from individual computer systems. The ability to award or revoke access to the storage device to individual host systems enables stricter access control policies to be used. Advantageously, a control policy can be revised if the loss or theft of a computer is determined, or when a change in the security or employment status of a user occurs.

It is not a requirement that the encryption key be stored on the host system. Instead, the encryption key can be provided as a “disconnected key” 34 that can be carried by a user in a disconnected device as shown in FIG. 4. For example, a code from a passive radio frequency identification (RFID) chip can be used to convey the key (or other watermarking information) to the host system. Similarly, other disconnected devices (e.g., Bluetooth devices, cell phones and USB key fobs) can provide the host system with the key information and the self-protecting storage device can have a private copy of the key. For a cell phone or similar portable electronic host device, the key can be kept in a close but disconnected location, such as in an RFID chip kept in a user's wallet. The cell phone can access self-protected storage in the cell phone as long as the cell phone is proximate to the wallet. Thus any personal information stored in a cell phone that is lost or stolen remains safe as the cell phone is no longer near the RFID chip.

In another variation, a self-protecting storage device can be configured to allow unprotected write access and protected read access. Thus the storage device can support covert digital recording (e.g., video recording and/or audio recording) using a generic recording device; however, the reading of the recorded data from the storage device can only be achieved by providing the correct encryption key. Thus the recording device does not require any information regarding how to gain read access to the storage device. In a further variation, the self-protecting storage device can be configured to include false recording data so that an unauthorized access (e.g., “unkeyed access”) attempt to read data from the storage device results in retrieval of false information.

The self-protecting storage device can also be used to protect information in obsolete systems. For example, many companies have difficulty disposing of computers and electronics devices while ensuring that company secrets and confidential information are erased from the associated storage devices. Use of self-protecting storage devices that are configured with unique keys provided by the computers and electronics devices limits access so that the storage device is only useful while it remains with its matched computer or electronics device. For example, a hard drive may be removed from a computer for use in a different computer. Using the removed hard drive in a different host computer causes the self-protecting hard drive to erase or otherwise protect its stored data upon determination of the unauthorized access attempt, thereby protecting any confidential information previously stored on the hard drive.

Finally, self-protecting storage devices provide a means by which certain types of intellectual property can be protected. For example, an MP3 player equipped with a self-protecting storage device can use a unique CPU identifier as its encryption key. Blocks of MP3 data are stored in files on the MP3 player at encrypted addresses corresponding to the key. Thus the MP3 data files are obfuscated in a manner unique to the MP3 player. This technique permits MP3 data files to be distributed to an MP3 player in a manner that is distinct and unique for the particular MP3 player. Copying the MP3 files to another MP3 player is ineffective as the other player uses a different encryption key. Thus music vendors can distribute copy protected MP3 files. Protection of software programs and information against unauthorized copying and access can be achieved in a similar manner.

While the invention has been shown and described with reference to specific embodiments, it should be understood by those skilled in the art that various changes in form and detail may be made therein without departing from the spirit and scope of the invention.

What is claimed is:

1. A self-protecting storage device comprising:
a data storage module; and
a verification module in communication with the data storage module and adapted to receive access commands from a host system, the verification module configured to detect a watermark inserted into the access commands by the host system and to determine if the watermark is associated with an authorized attempt to access the data storage module, the verification module enabling access to the data storage module when the watermark is determined to be associated with an authorized attempt to access the data storage module.

2. The self-protecting storage device of claim 1 wherein the watermark is a digital signature.

3. The self-protecting storage device of claim 1 wherein the watermark is a verification code.

4. The self-protecting storage device of claim 1 wherein the watermark comprises encrypted block addresses included in the access commands.

5. The self-protecting storage device of claim 1 wherein the watermark is a predefined relationship between the access commands.

6. The self-protecting storage device of claim 4 further comprising a decryption module in communication with the verification module, the decryption module receiving the access commands from the host system and providing decrypted block addresses to the verification module, wherein the verification module determines if the watermark is associated with an authorized attempt to access the data storage module through a comparison of the decrypted block addresses and a predetermined pattern of block addresses.

7. The self-protecting storage device of claim 6 wherein the predetermined pattern of block addresses comprises a serial progression of block addresses.

8. The self-protecting storage device of claim 7 wherein the watermark is determined to be associated with an authorized attempt to access the data storage module if a number of variations in the decrypted block addresses from the serial progression of the block addresses does not exceed a maximum allowable number of variations.

9. The self-protecting storage device of claim 1 further comprising the host system and wherein the host system comprises memory adapted to store at least one encryption key.

10. The self-protecting storage device of claim 1 further comprising the host system and wherein the host system is configured to acquire the watermark for the access commands based on a disconnected mechanism from a device disposed proximate to the host system.

11. The self-protecting storage device of claim 6 wherein the verification module comprises a saturating counter that generates a value indicating a degree to which the decrypted block addresses match the predetermined pattern of block addresses.

12. The self-protecting storage device of claim 4 wherein data are stored in the data storage module at the decrypted block addresses.

13. The self-protecting storage device of claim 1 wherein the verification module initiates execution of a predetermined function of the data storage module if the received access commands do not have a watermark associated with an authorized attempt to access the data storage module.

14. The self-protecting storage device of claim 13 wherein the predetermined function comprises erasure of data in at least a portion of the data storage module.

15. The self-protecting storage device of claim 13 wherein the predetermined function comprises providing access to false data stored in the data storage module.

16. The self-protecting storage device of claim 13 wherein the predetermined function comprises preventing access to the data storage module until an unlock sequence is received.

17. The self-protecting storage device of claim 13 wherein the predetermined function comprises preventing access to the data storage module for a predetermined time period.

18. A method for accessing a protected storage device, the method comprising:
generating a plurality of access commands for the protected storage device;
inserting a watermark into the access commands;
sending the access commands with the inserted watermark to the protected storage device; and
providing access to the protected storage device if the watermark is determined to be associated with an authorized attempt to access the protected storage device.

19. The method of claim 18 wherein the access commands comprise an attempt to write data to the protected storage device.

20. The method of claim 18 wherein the access commands comprise an attempt to read data from the protected storage device.

21. The method of claim 18 wherein the watermark is a digital signature.

22. The method of claim 18 wherein the watermark is a verification code.

23. The method of claim 18 wherein the watermark comprises encrypted block addresses included in the access commands.

24. The method of claim 18 wherein the watermark is a predefined relationship between the access commands.

25. The method of claim 23 wherein determining if the watermark is associated with an authorized attempt to access the protected storage device comprises:
decrypting the encrypted block addresses included in the access commands; and
comparing the decrypted block addresses to a predetermined pattern of block addresses.

26. The method of claim 25 wherein the predetermined pattern of block addresses comprises a serial progression of block addresses.

27. The method of claim 25 wherein access is provided to the protected storage device if a number of variations in a serial progression of the decrypted block addresses relative to the predetermined pattern of block addresses does not exceed a maximum allowable number of variations.

28. The method of claim 18 further comprising executing a predetermined function of the protected storage device if the access commands do not have a watermark associated with an authorized attempt to access the protected storage device.

29. The method of claim 28 wherein the predetermined function comprises erasure of data stored in the protected storage device.

30. The method of claim 28 wherein the predetermined function comprises providing access to false data stored in the protected storage device.

31. The method of claim 28 wherein the predetermined function comprises preventing access to the protected storage device until an unlock sequence is detected.

32. The method of claim 28 wherein the predetermined function comprises preventing access to the protected storage device for a predetermined time period.
